(19) United States
(12) Patent Application Publication
(10) Pub. No.: US 2023/0230144 A1
(43) Pub. Date: Jul. 20, 2023

(54) AUTHENTIC REVIEW IDENTIFICATION AND DISPLAY

(71) Applicants: Reza Lavasanijou, Broadview Heights, OH (US); Farbod Rohani, Redwood City, CA (US); Humberto Jose De las Casas Zolezzi, San Mateo, CA (US)

(72) Inventors: Reza Lavasanijou, Broadview Heights, OH (US); Farbod Rohani, Redwood City, CA (US); Humberto Jose De las Casas Zolezzi, San Mateo, CA (US)

(21) Appl. No.: 18/097,750

(22) Filed: Jan. 17, 2023

Related U.S. Application Data
(60) Provisional application No. 63/299,975, filed on Jan. 15, 2022.

(51) Int. Cl. G06Q 30/0601

(52) U.S. Cl. CPC G06Q 30/0631; G06Q 30/0643

(57) ABSTRACT

In an example, one or more internet resources including reviews of a first item may be identified. The one or more internet resources may be analyzed to identify a reviews of the first item. A subset of reviews may be selected from among the reviews based upon a determination that reviews of the subset of reviews meet one or more conditions including a condition that a review is authentic and/or a condition that a review score corresponding to a review quality of a review meets a threshold review score. First review information associated with the first item may be generated based upon the subset of reviews. A request for review information may be received from a client device. In response to determining that the request is associated with the first item, a review interface, including graphical objects indicative of the first review information, may be displayed via the client device.

### RELATED APPLICATION

This application claims the benefit of U.S. Provisional Patent Application No. 63/299,975, filed Jan. 15, 2022, which is incorporated herein by reference in its entirety.

### BACKGROUND

Many online sellers may feature reviews associated with products and/or services on their webpage. A user may use the reviews to ascertain the quality of a product and/or service and decide whether or not to purchase the product and/or service.

### SUMMARY

In accordance with the present disclosure, one or more systems and/or techniques for identifying and/or presenting reviews associated with items are provided. In an example, a first item may be identified. One or more internet resources associated with the first item may be identified. Each internet resource of the one or more internet resources comprises one or more reviews of the first item. The one or more internet resources may be analyzed to identify a plurality of reviews of the first item. A subset of reviews may be selected from among the plurality of reviews based upon a determination that reviews of the subset of reviews are authentic. First review information associated with the first item may be generated based upon the subset of reviews. A request for review information may be received from a client device. It may be determined that the request is associated with the first item. In response to the determining that the request is associated with the first item, an authentic review interface may be displayed via the client device, wherein the authentic review interface comprises one or more graphical objects indicative of the first review information associated with the first item.

In an example, a first item may be identified. One or more internet resources associated with the first item may be identified. Each internet resource of the one or more internet resources comprises one or more reviews of the first item. The one or more internet resources may be analyzed to identify a plurality of reviews of the first item. A subset of reviews may be selected from among the plurality of reviews based upon a determination that reviews of the subset of reviews meet one or more conditions comprising a condition that a review is authentic and/or a condition that a review score corresponding to a review quality of a review meets a threshold review score. First review information associated with the first item may be generated based upon the subset of reviews. A request for review information may be received from a client device. It may be determined that the request is associated with the first item. In response to the determining that the request is associated with the first item, a review interface may be displayed via the client device, wherein the review interface comprises one or more graphical objects indicative of the first review information associated with the first item.

### DESCRIPTION OF THE DRAWINGS

FIG. 1 is an illustration of an exemplary method for identifying and/or presenting reviews associated with items.

FIG. 2A is a component block diagram illustrating an exemplary system for identifying and/or presenting reviews associated with items, where one or more first internet resources are identified.

FIG. 2B is a component block diagram illustrating an exemplary system for identifying and/or presenting reviews associated with items, where a first plurality of reviews is identified.

FIG. 2C is a component block diagram illustrating an exemplary system for identifying and/or presenting reviews associated with items, where a subset of reviews is selected using an authentic review identification module.

FIG. 2D is a component block diagram illustrating an exemplary system for identifying and/or presenting reviews associated with items, where one or more first graphical objects of an authentic review interface and/or content of a third internet resource are displayed via a first client device.

FIG. 2E is a component block diagram illustrating an exemplary system for identifying and/or presenting reviews associated with items, where one or more second graphical objects of an authentic review interface and/or content of a third internet resource are displayed via a first client device.

FIG. 2F is a component block diagram illustrating an exemplary system for identifying and/or presenting reviews associated with items, where a first authentic review report is displayed via a first client device.

FIG. 2G is a component block diagram illustrating an exemplary system for identifying and/or presenting reviews associated with items, where a first authentic review report is displayed via a first client device.

FIG. 2H is a component block diagram illustrating an exemplary system for identifying and/or presenting reviews associated with items, where a list of reviews, comprising reviews of a subset of reviews, is displayed via a first client device.

FIG. 3 is an illustration of an exemplary computer-readable medium comprising processor-executable instructions, wherein the processor executable instructions may be configured to embody one or more of the provisions set forth herein.

FIG. 4 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

One or more systems and/or techniques for identifying and/or presenting reviews associated with items are provided. As online shopping and/or purchasing become increasingly prevalent in the market, providing reviews associated with items may be beneficial for users and/or buyers who wish to discern a quality of an item, such as a product and/or a service. For example, a user may determine whether or not to purchase an item based upon reviews associated with the item. Brands, sellers and/or buyers may stand to benefit from having reviews that are authentic. However, it may prove difficult for shopping platforms to provide principally authentic reviews that are trusted by users. In some cases, reviews of an item are of low quality and/or may include inaccurate information and/or the ratings may not be sufficient indicators of the quality of the item. Further, a user and/or a buyer may be offered an item free of charge and/or some other form of compensation in return for submitting a positive review and/or a high rating (5 stars for example) of the item on the shopping platform, review platform, etc. irrespective of the quality of the item. Thus, it may prove difficult for users and/or prospective buyers to determine whether or not a positive review and/or a high rating actually indicate a high quality item, or rather has been left by a reviewer merely to receive compensation in return for leaving the positive review and/or the high rating.

Thus, in accordance with one or more of the techniques presented herein, a review system is provided. The review system may extract reviews of a first item from one or more first internet resources, and/or may select a subset of reviews, from the reviews, based upon a determination that reviews of the subset of reviews are authentic and/or are associated with review scores (e.g., indicative of review quality) that meet a threshold review score. First review information associated with the first item may be generated based upon the subset of reviews. An authentic review interface comprising graphical objects indicative of the first review information may be displayed via a client device. In an example, the first review information may comprise at least one of the subset of reviews, item attributes of reviews of the subset of reviews, an item rating based upon ratings of the subset of reviews, etc. It may be appreciated that by selecting the subset of reviews based upon a determination that the subset of reviews are authentic and/or are associated with review scores that meet the threshold review score, the first review information may provide authentic, accurate, etc. information that prospective buyers and/or users can trust and/or use to discern the quality of the first item more accurately.

In some examples, the authentic review interface may be displayed in conjunction with displaying content of a shopping web page of a shopping platform that is different than one or more internet resources (of the one or more first internet resources) from which one or more reviews of the subset of reviews are extracted. For example, the authentic review interface and the content of the shopping web page may be displayed concurrently (when the shopping web page is accessed by the client device, for example). By displaying the authentic review interface in conjunction with content of the shopping web page, a user of the client device may be provided with reviews (e.g., authentic reviews from other internet resources) that the user would otherwise not have access to when accessing the shopping web page, and thus may enable the user to make a more informed purchase decision.

In some examples, the authentic review interface may display an authentic review report (e.g., a review summary) that summarizes information provided in the subset of reviews. For example, the authentic review interface may comprise at least one of indications of item attributes of the first item discussed in the subset of reviews, indications of negative item attributes of the first item discussed in the subset of reviews, indications of positive item attributes of the first item discussed in the subset of reviews, metrics associated with the negative attributes and/or the positive attributes, etc. Accordingly, by displaying the authentic review report, a user of the client device may more quickly and/or conveniently identify main points of the subset of reviews using the authentic review report, thereby enabling the user to more conveniently make an informed purchase decision.

In some examples, the plurality of reviews may be extracted from internet resources of a plurality of platforms (e.g., shopping platforms and/or reviewing platforms, wherein platforms of the plurality of platforms may be different from each other), thereby expanding a pool of candidate reviews from which the subset of reviews can be selected. Accordingly, an increased quantity of authentic reviews may be selected for inclusion in the subset of reviews, and thus, an increased quantity of authentic reviews may be provided to a user of the client device, thereby enabling the user to make a more informed purchase decision.

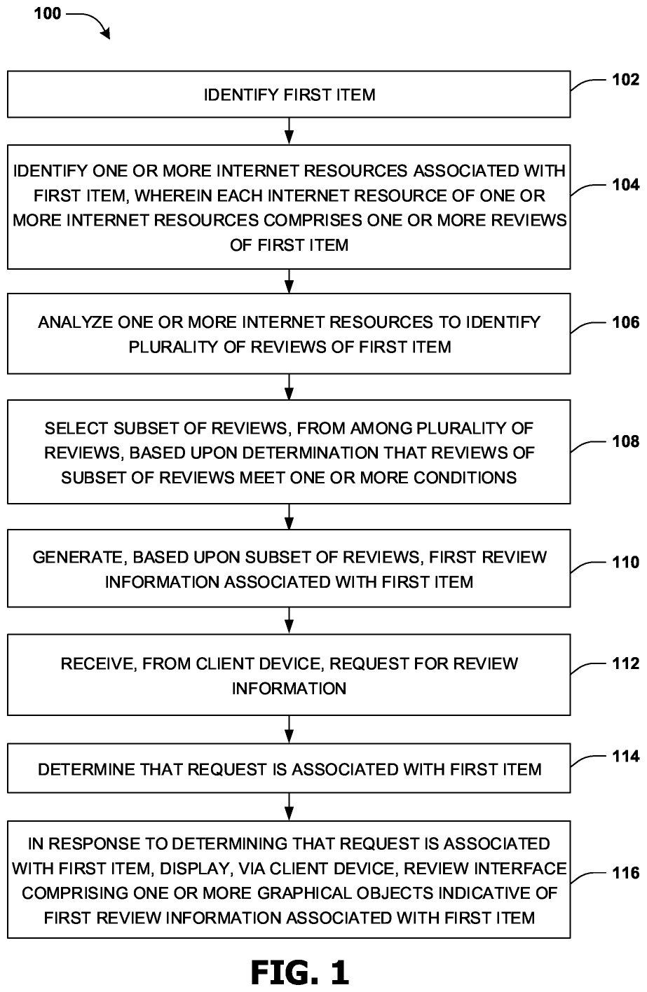

An embodiment for identifying and/or presenting reviews associated with items is illustrated by an example method 100 of FIG. 1. In some examples, a review system is provided. The review system may identify authentic reviews of items from multiple sources, and may provide the authentic reviews and information determined based upon the authentic reviews for users such that the users can make informed decisions (e.g., shopping decisions) on which items to purchase.

At 102, a first item is identified. In some examples, the first item may correspond to a product and/or a service provided and/or sold via one or more shopping platforms. In an example, the first item may be identified in based upon a determination that the first item is available for purchase using a shopping platform, such as at least one of a shopping website, a shopping application (e.g., at least one of a mobile application, web application, etc.), etc. that provides an interface for making purchases of items, such as products and/or services. In an example, internet resources (e.g., web pages) of one or more shopping platforms may be analyzed to identify items that are available for purchase using the one or more shopping platforms. For example, internet resources (of the one or more shopping platforms) associated with selling the items may be identified via analyzing the internet resources. In an example, the internet resources may correspond to web pages, of the one or more shopping platforms, providing interfaces with which the items may be purchased. In an example, the first item may be identified based upon identification of an internet resource, of a shopping platform, that comprises information associated with the first item and/or that provides an interface with which the first item may be purchased. In some examples, first item identification information associated with the first item may be determined based upon the internet resource. In an example, the first item identification information may comprise at least one of a first item name of the first item, a first item identifier of the first item, a first Universal Product Code (UPC) of the first item, etc. Alternatively and/or additionally, the first item may be identified based upon a message received by the review system, wherein the message may be indicative of the first item identification information.

At 104, one or more first internet resources associated with the first item may be identified. Each internet resource of the one or more first internet resources comprises one or more reviews of the first item. In an example, an internet resource of the one or more first internet resources may comprise a shopping internet resource, of a shopping platform, associated with selling the first item (e.g., the internet resource may correspond to a web page, of the shopping platform, where the first item can be purchased), wherein the internet resource comprises one or more reviews of the first item (e.g., the one or more reviews may be posted by users that have user accounts associated with the internet resource and/or that purchased the first item using the internet resource). Alternatively and/or additionally, an internet resource of the one or more first internet resources may comprise a review internet resource, of a reviewing platform, such as at least one of a reviewing website, a reviewing application (e.g., at least one of a mobile application, web application, etc.), etc., that provides an interface for posting and/or viewing reviews of items (e.g., the internet resource may correspond to a web page, of the reviewing platform, comprising reviews of the first item).

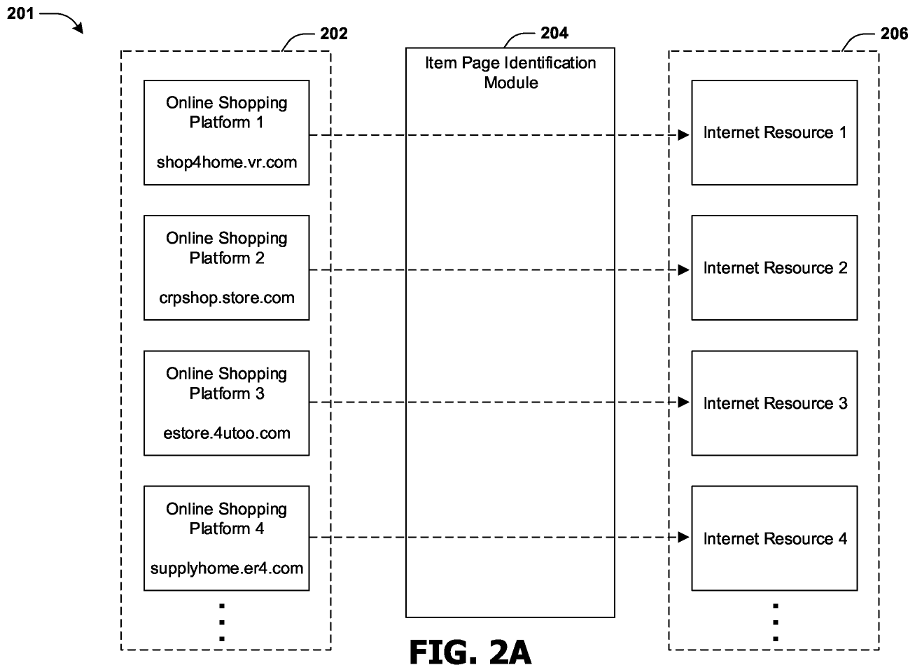

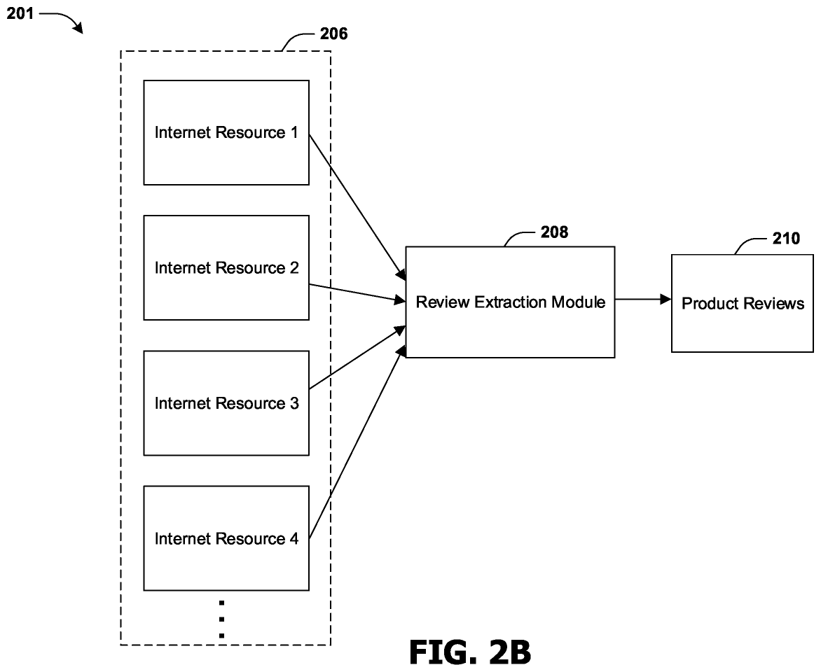

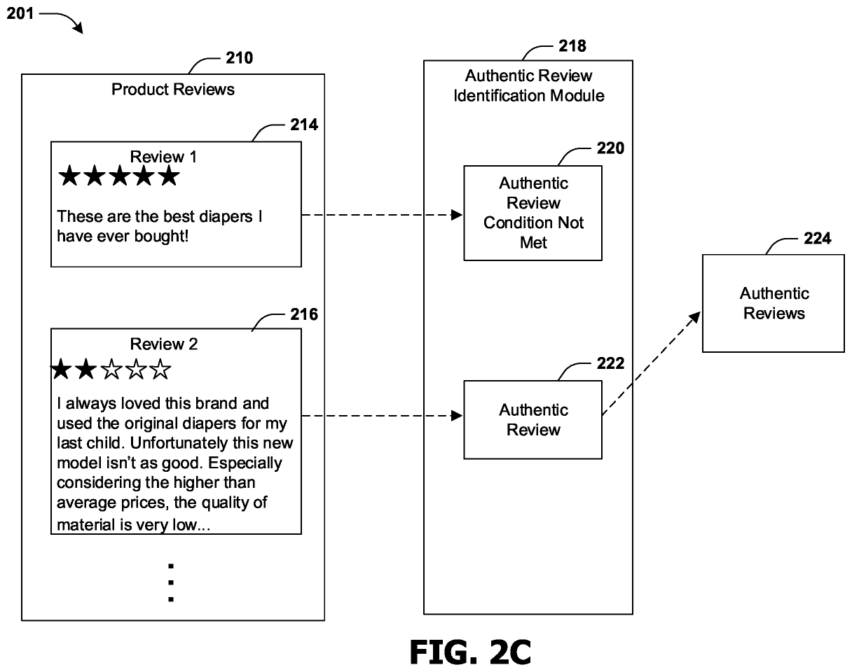

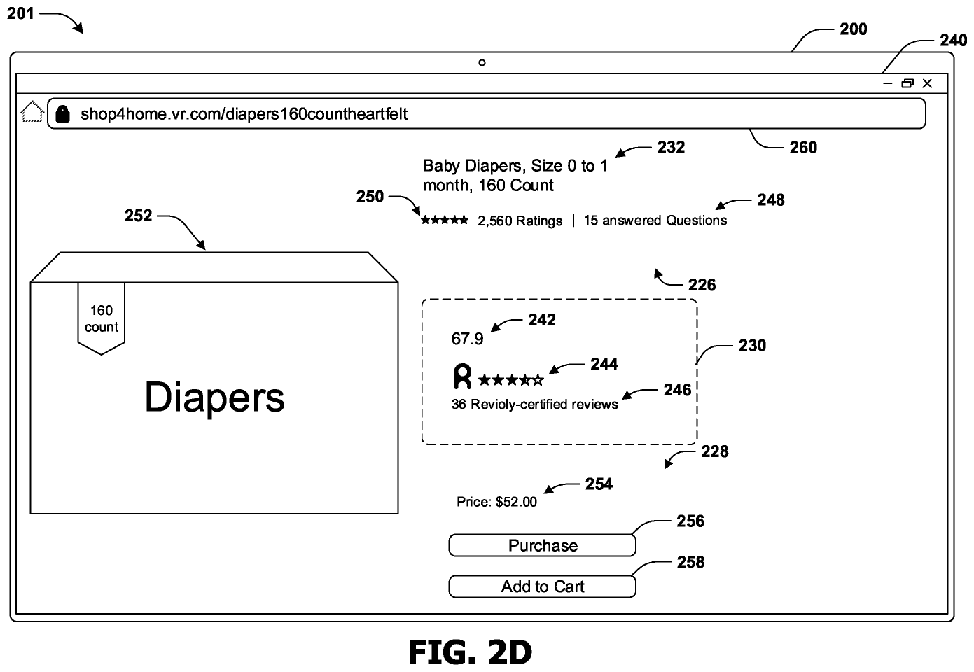

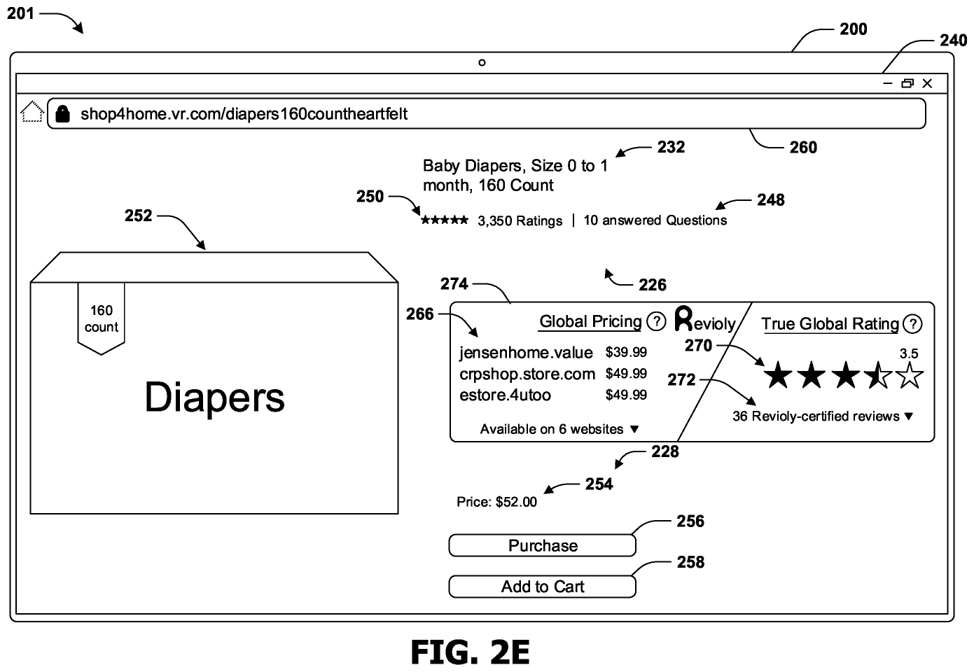

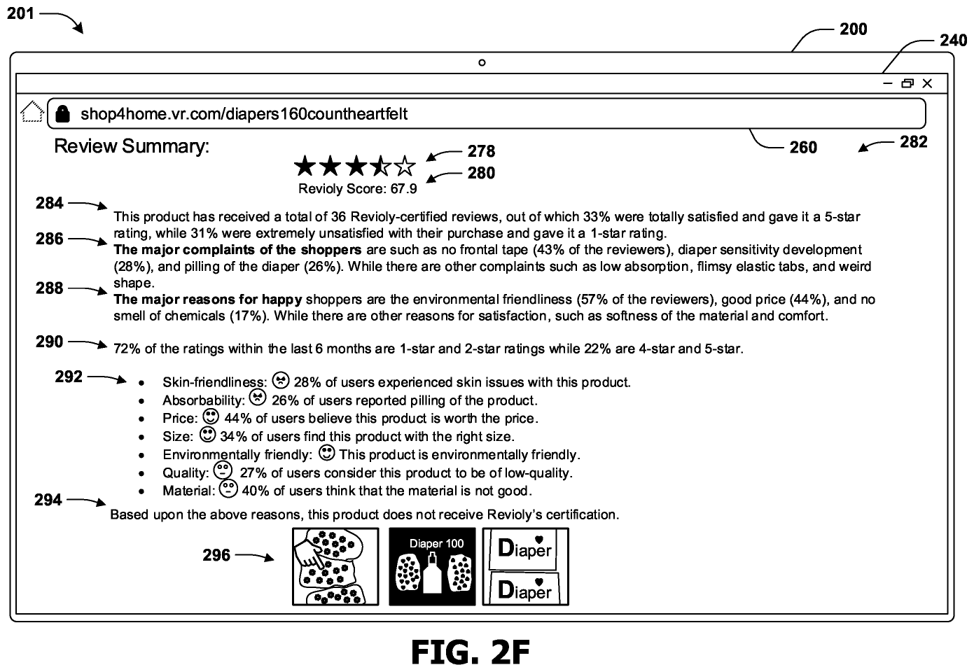

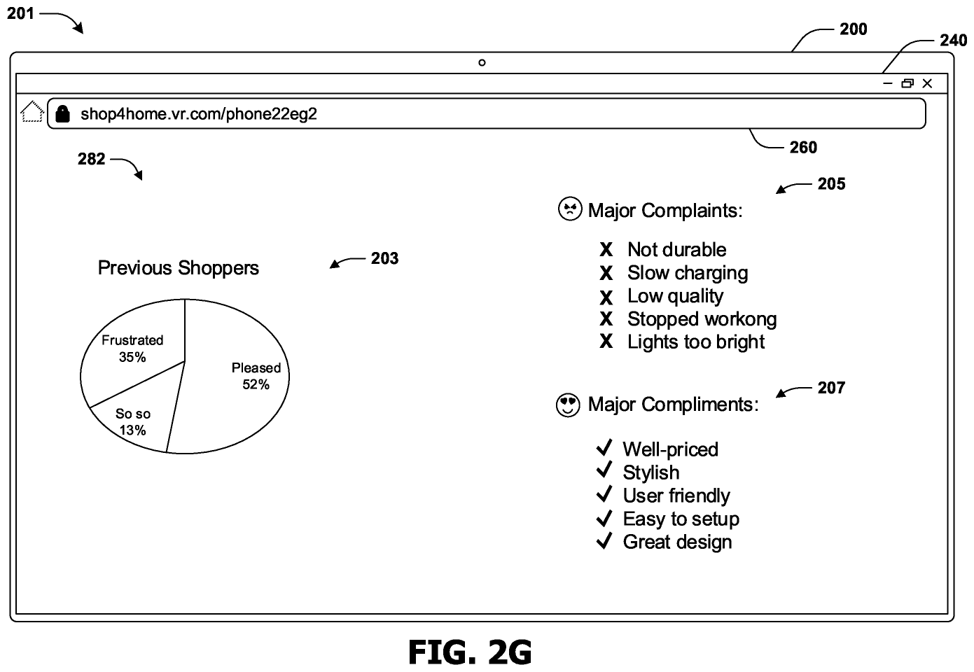

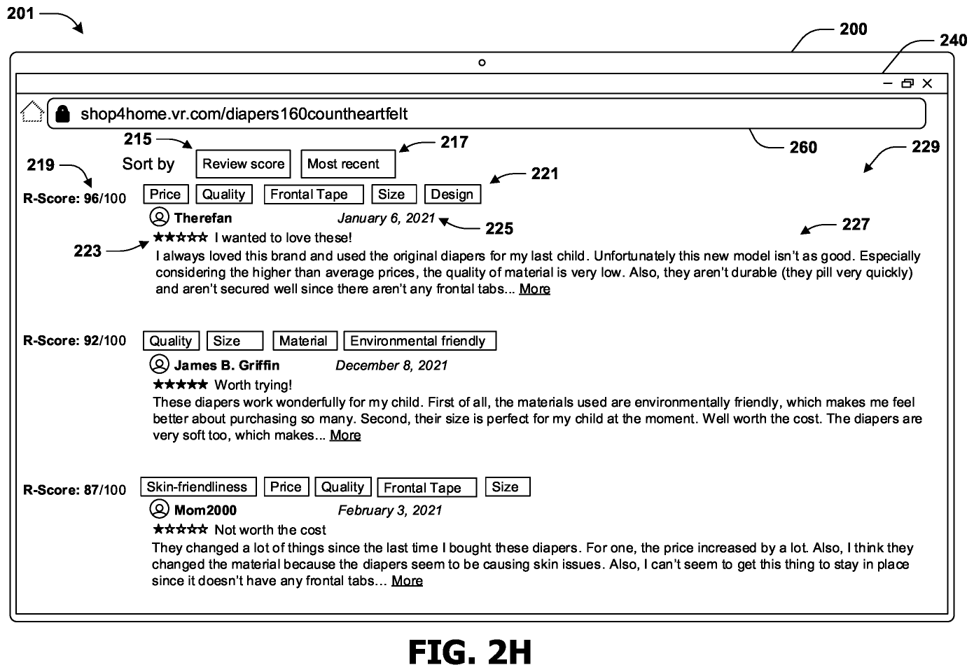

FIGS. 2A-2H illustrate examples of a system 201 for identifying and/or presenting reviews associated with items, described with respect to the method 100 of FIG. 1. FIG. 2A illustrates identification of the one or more first internet resources (shown with reference number 206), according to some exemplary embodiments. In an example, information associated with a plurality of shopping platforms 202 may be analyzed (using an item page identification module 204, for example) to identify the one or more first internet resources 206. The plurality of shopping platforms may comprise multiple shopping websites and/or multiple shopping applications.

In an example, the plurality of shopping platforms may comprise at least one of a first shopping platform “Online Shopping Platform 1” and/or a second shopping platform “Online Shopping Platform 2” (and/or other shopping platforms). In an example, first information associated with the first shopping platform may be analyzed to identify a first internet resource “Internet Resource 1” (e.g., a first shopping internet resource of the first shopping platform) that is associated with selling the first item (e.g., the first internet resource provides an interface with which the first item can be purchased) and/or that comprises one or more first reviews of the first item. The first information (based upon which the first internet resource is identified) may comprise at least one of internet resources (e.g., web pages) of the first shopping platform, inventory information indicative of an inventory of items available for purchase via the first shopping platform, etc. The first internet resource may be included in the one or more first internet resources 206 based upon the determination that the first internet resource is associated with selling the first item and/or that the first internet resource comprises the one or more first reviews of the first item. Alternatively and/or additionally, second information associated with the second shopping platform may be analyzed to identify a second internet resource “Internet Resource 2” (e.g., a second shopping internet resource of the first shopping platform) that is associated with selling the first item (e.g., the second internet resource provides an interface with which the first item can be purchased) and/or that comprises one or more second reviews of the first item, wherein the second internet resource may be included in the one or more first internet resources 206. In an example, the second shopping platform may be different than the first shopping platform. For example, the first shopping platform and the second shopping platform may be independent and/or separate from each other (e.g., the first shopping platform and the second shopping platform may be managed, hosted and/or owned by different entities).

At 106, the one or more first internet resources 206 may be analyzed to identify a first plurality of reviews of the first item. For example, the first plurality of reviews may comprise the one or more first reviews in the first internet resource, the one or more second reviews in the second internet resource, etc. In an example, the first plurality of reviews may be extracted from the one or more first internet resources 206. In some examples, identification of the one or more first internet resources 206 and/or identification of the first plurality of reviews of the first item (and/or extraction of the first plurality of reviews from the one or more first resources 206) may be performed using a data extraction module (e.g., a web scraping and/or harvesting module). FIG. 2B illustrates identification (and/or extraction) of the first plurality of reviews (shown with reference number 210), according to some exemplary embodiments. In an example, the first plurality of reviews 210 may be extracted from the one or more first internet resources 206 using a review extraction module 208 (e.g., a data extraction module configured to extract reviews from internet resources).

At 108, a subset of reviews is selected from among the first plurality of reviews 210 based upon a determination (e.g., a prediction) that reviews of the subset of reviews meet a set of conditions (e.g., a set of one or more conditions). In some examples, the set of conditions comprises a first condition that a review is determined to be authentic and/or a second condition that a review score of the review meets a threshold review score. In an example, a review score may correspond to a quality of a review, such as a value and/or usefulness of the review in assisting a user to make a purchase decision (e.g., a decision of whether or not to purchase the first item). In an example, the set of conditions comprises the first condition and does not comprise the second condition (e.g., reviews, of the first plurality of reviews 210, that are determined to be authentic are included in the subset of reviews). In an example, the set of conditions comprises the first condition and the second condition (e.g., reviews, of the first plurality of reviews 210, that are determined to be authentic and are associated with review scores exceeding the threshold review score are included in the subset of reviews).

In some examples, whether or not a first review of the first plurality of reviews 210 meets the set of conditions may be determined. For example, the determination of whether or not the first review meets the set of conditions comprises a determination of whether or not the first review meets the first condition.

In some examples, whether or not the first review meets the first condition (e.g., the first condition that the first review is determined to be authentic) may be determined based upon at least one of the first review, a reviewer of the first review (e.g., a user and/or user account that posted the first review), a source associated with the first review, etc. In some examples, a determination that the first review is authentic may correspond to a determination (e.g., prediction) that at least one of the first review provides an evaluation (e.g., an honest evaluation) of the first item based upon a user's experience using the first item, that the first review is not posted in an attempt to receive compensation from an entity (e.g., the entity may be a seller of the first item that may wish to promote the first item or a competitor that may wish to disparage the first item), that the first review is not posted (by a bot or an agent of the entity, for example) in an attempt to promote or disparage the first item, etc. Alternatively and/or additionally, a determination that the first review does not meet the first condition may correspond to a determination (e.g., prediction) that at least one of the first review is not based upon a user's experience using the first review, that the first review is posted in an attempt to receive compensation from the entity, that the first review is posted (by a bot or an agent of the entity, for example) in an attempt to promote or disparage the first item, etc.

In an example, whether or not the first review meets the first condition may be determined based upon reviews associated with a user account of the reviewer of the first review (e.g., reviews posted by the user account of the reviewer on a platform, such as a shopping platform and/or reviewing platform). Alternatively and/or additionally, a reviewer confidence score associated with the reviewer may be determined based upon the reviews associated with the reviewer. In an example, the reviewer confidence score is indicative of a likelihood that a review posted by the reviewer is an authentic reviews.

In an example, it may be determined that the first review does not meet the first condition based upon a determination that a third condition associated with the reviewer is met, wherein the third condition is a condition that the reviewer posted a plurality of reviews associated with items of the same manufacturer and/or seller and that the plurality of reviews exceed a threshold quantity of reviews (e.g., the threshold quantity of reviews may correspond to a threshold proportion of all reviews posted by the reviewer on the platform) and/or that at least a threshold proportion of the plurality of reviews are either positive reviews or negative reviews (e.g., which may indicate that the reviewer is attempting to promote the manufacturer and/or seller or the reviewer is attempting to disparage the manufacturer and/or seller).

Alternatively and/or additionally, the reviewer confidence score may be determined based upon whether or not the third condition is met (e.g., the reviewer confidence score may be lower if the third condition is met than if the third condition is not met).

In an example, the reviewer confidence score may be determined based upon ratings of reviews posted by the user account of the first reviewer. For example, a quantity of mid-range ratings, of the ratings, may be determined. A mid-range rating may correspond to a rating within a mid-range of a rating scale. In an example in which the ratings are on a rating scale from 1 through 5, the mid-rating range may comprise 2 through 4. Alternatively and/or additionally, a quantity of extreme ratings, of the ratings, corresponding to extreme ratings (e.g., highest and/or lowest possible ratings on the rating scale, such as ratings of 1 or 5 on a scale of 1 through 5) may be determined. The reviewer confidence score may be determined based upon the quantity of mid-range ratings and/or the quantity of extreme ratings. In an example, the reviewer confidence score may be a function of the quantity of mid-range ratings and/or one or more other values, where the reviewer confidence score may increase with an increase of the quantity of mid-range ratings. In an example, the reviewer confidence score may be a function of the quantity of extreme ratings and/or one or more other values, where the reviewer confidence score may decrease with an increase of the quantity of extreme ratings. Alternatively and/or additionally, the reviewer confidence score may be determined based upon a combination of the quantity of mid-range ratings and/or the quantity of extreme ratings (e.g., a ratio of mid-range ratings to extreme ratings, where the reviewer confidence score may increase with an increase of the ratio of mid-range ratings to extreme ratings).

Alternatively and/or additionally, it may be determined that the first review does not meet the first condition based upon a determination that a fourth condition associated with the reviewer is met, wherein the fourth condition is a condition that at least one of the quantity of mid-range ratings does not meet (e.g., does not exceed) a mid-range rating quantity threshold, the quantity of extreme ratings meets (e.g., exceeds) an extreme rating quantity threshold, the ratio of mid-range ratings to extreme ratings does not meet (e.g., does not exceed) a threshold ratio, etc.

In an example, it may be determined that the first review does not meet the first condition based upon a determination that a fifth condition associated with the reviewer is met. The fifth condition is a condition that one or more reviews posted by the reviewer are flagged as inauthentic (e.g., fake) reviews (e.g., the one or more reviews may be flagged as inauthentic by a third party system or by the review system, such as using one or more of the techniques provided herein).

In an example, whether or not the first review meets the first condition may be determined based upon a length of the first review (e.g., the length may correspond to at least one of a quantity of characters, a quantity of words, etc. of the first review), a rating of the first review and/or a quantity of item attributes (e.g., item attributes) discussed in the first review (e.g., item attributes discussed in the first review may be determined using one or more of the techniques provided herein). In some examples, compared to authentic reviews of an item, inauthentic reviews may be shorter and/or have discussion of fewer attributes of the item. Alternatively and/or additionally, compared to authentic reviews, inauthentic reviews may be more likely to have an extreme rating (rather than a mid-range rating, for example).

Alternatively and/or additionally, a review confidence score associated with the first review may be determined based upon the length of the first review, the rating of the first review and/or the quantity of item attributes of the first review. The review confidence score corresponds to a likelihood, determined based upon the first review, that the first review is authentic. In an example, the review confidence score may be a function of the length of the first review and/or one or more other values, wherein the review confidence score may increase with an increase of the length of the first review. Alternatively and/or additionally, the rating of the first review being a mid-range rating may result in a higher value of the review confidence score than the rating of the first review being an extreme rating. Alternatively and/or additionally, the review confidence score may be a function of the quantity of item attributes and/or one or more other values, wherein the review confidence score may increase with an increase of the quantity of item attributes.

In an example, whether or not the first review meets the first condition may be determined based upon the source of the first review. The source of the first review may correspond to at least one of an internet resource from which the first review is extracted, a platform (e.g., a website and/or application) to which the internet resource belongs (e.g., a platform, such as a shopping platform and/or a review platform, that comprises the internet resource), etc. In an example, the first review may be determined to meet the first condition based upon a determination that the source of the first review is a verified third-party source (e.g., a source associated with a reviewing platform that is separate from a shopping platform, a seller, a brand, etc. associated with the first item) that is known to provide authentic reviews.

In some examples, the first review may be determined to meet the first condition (e.g., the first review may be determined to be an authentic review) based upon a determination that at least one of the third condition associated with the reviewer is not met, the fourth condition associated with the reviewer is not met, the fifth condition associated with the reviewer is not met, the reviewer confidence score associated with the first reviewer meets (e.g., exceeds) a threshold reviewer confidence score, the review confidence score associated with the first reviewer meets (e.g., exceeds) a threshold review confidence score, a combination of the reviewer confidence score and the review confidence score meets (e.g., exceeds) a threshold value, etc.

Alternatively and/or additionally, the first review may be determined not to meet the first condition (e.g., the first review may not be determined to be an authentic review) based upon a determination that at least one of the third condition associated with the reviewer is met, the fourth condition associated with the reviewer is met, the fifth condition associated with the reviewer is met, the reviewer confidence score associated with the first reviewer does not meet (e.g., does not exceed) the threshold reviewer confidence score, the review confidence score associated with the first reviewer does not meet (e.g., does not exceed) the threshold review confidence score, the combination of the reviewer confidence score and the review confidence score does not meet (e.g., does not exceed) a threshold value, etc.

In some examples, the determination of whether or not the first review meets the set of conditions comprises a determination of whether or not the first review meets the second condition that a first review score, indicative of a review quality of the first review, meets (e.g., exceeds) the threshold review score.

In an example, the first review score may be determined based upon the quantity of item attributes discussed in the first review. For example, the first review score may be a function of the quantity of item attributes of the first review and/or one or more other values, where the first review score may increase with an increase of the quantity of item attributes of the first review.

In an example, the first review score may be determined based upon the length of the first review. In an example, the first review score may be a function of the length of the first review and/or one or more other values, wherein the first review score may increase with an increase of the length of the first review.

Alternatively and/or additionally, the first review score may be determined based upon at least one of an amount of information and/or details of a first item provided in the first review, whether or not the first review contains language and/or terms appropriate for describing the first item, whether or not pros and/or cons of the first item are provided in the first review, etc. which may be determined by analyzing the first review using one or more language processing techniques (e.g., one or more natural language processing (NLP) techniques), one or more machine learning techniques and/or other techniques. Alternatively and/or additionally, the first review score may be determined based upon reactions to the first review indicated by other users (e.g., the reactions may be determined by analyzing an internet resource from which the first review is extracted). For example, the first review score may be determined based upon a quantity of positive reactions to the first review (e.g., likes and/or indications that the first review was helpful to one or more users that read the first review) and/or a quantity of negative reactions to the first review (e.g., dislikes and/or indications that the first review was unhelpful to one or more users that read the first review). For example, the first review score may be a function of the quantity of positive reactions and/or one or more other values, where the first review score may increase with an increase of the quantity of positive reactions. Alternatively and/or additionally, the first review score may be a function of the quantity of negative reactions and/or one or more other values, where the first review score may decrease with an increase of the quantity of negative reactions.

Reviews provided by reviewers of a target audience of an item may provide more accurate description of the item and/or may provide more accurate indicators of the quality of the item. In an example, the first review score may be determined based upon a reviewer profile associated with the reviewer and/or a target profile associated with a target audience of the first item. For example, the first review score may be higher if the reviewer belongs to the target audience and/or is more similar to characteristics associated with the target audience. The reviewer profile may be indicative of one or more first characteristics of the reviewer, such as at least one of an age and/or age range associated with the reviewer, a location associated with the reviewer, an education level associated with the reviewer, user activity associated with the reviewer, one or more past purchases associated with the reviewer, one or more interests associated with the reviewer, an income level associated with the reviewer, a social status level associated with the reviewer, one or more ethnicities associated with the reviewer, one or more shopping habits associated with the reviewer, one or more household characteristics associated with the reviewer, an occupation associated with the reviewer, one or more physical features associated with the reviewer, a body type associated with the reviewer, etc. The target profile may be indicative of one or more second characteristics of the target audience, such as at least one of an age and/or age range associated with the target audience, a location associated with the target audience, an education level associated with the target audience, user activity associated with the target audience, one or more past purchases associated with the target audience, one or more interests associated with the target audience, an income level associated with the target audience, a social status level associated with the target audience, one or more ethnicities associated with the target audience, one or more shopping habits associated with the target audience, one or more household characteristics associated with the target audience, an occupation associated with the target audience, one or more physical features associated with the target audience, a body type associated with the target audience, etc. A measure of similarity between the one or more first characteristics and the one or more second characteristics may be determined. For example, the measure of similarity may be based upon characteristics of the one or more first characteristics (associated with the reviewer) that match characteristics of the one or more second characteristics (associated with the target audience). For example, the measure of similarity may be based upon a quantity of the matching characteristics between the one or more first characteristics and the one or more second characteristics. In an example, the first review score may be a function of the measure of similarity and/or one or more other values, where the first review score may increase with an increase of the measure of similarity. In an example in which the first item is a tool used in an engineering field, the target audience may correspond to users with an occupation in the engineering field (e.g., the one or more second characteristics may comprise the occupation in the engineering field). Accordingly, the first review score may be higher if the reviewer profile of the reviewer is indicative of the reviewer having an occupation in the engineering field than if the reviewer profile is indicative of the reviewer having an occupation unrelated to the engineering field.

In some examples, whether or not other reviews (other than the first review) of the first plurality of reviews 210 meet the set of conditions may be determined using one or more of the techniques provided herein for determining whether or not the first review meets the set of conditions.

FIG. 2C illustrates selection of the subset of reviews (shown with reference number 224) using an authentic review identification module 218, according to some exemplary embodiments. In the example shown in FIG. 2C, the set of conditions comprises the first condition that the reviews of the subset of reviews 224 are determined to be authentic. In an example, the authentic review identification module 218 may determine (e.g., predict) 220 that a review 214 of the first plurality of reviews 210 does not meet the first condition (e.g., the review 214 is not determined to be authentic and/or is determined to be inauthentic), and thus may not include the review 214 in the subset of reviews 224. In an example, the authentic review identification module 218 may determine (e.g., predict) 222 that a review 216 of the first plurality of reviews 210 meets the first condition (e.g., the review 216 is determined to be authentic), and may include the review 216 in the subset of reviews 224 based upon the determination 222 (and/or based upon a determination that a review score of the review meets the threshold review score).

At 110, first review information associated with the first item is generated based upon the subset of reviews 224. In an example, the first review information comprises reviews of the subset of reviews 224. Alternatively and/or additionally, the first review information may comprise item attributes associated with the subset of reviews 224. For example, a plurality of sets of item attributes associated with reviews of the subset of reviews 224 may be determined based upon the subset of reviews 224 (e.g., for each review of the subset of reviews 224, a set of item attributes, of the first item, discussed (e.g., mentioned and/or referred to) in the review may be determined). For example, each set of item attributes of the plurality of sets of item attributes may comprise one or more item attributes of the first item discussed in a review of the subset of reviews 224.

In an example in which the first review is included in the subset of reviews 224 (e.g., based upon the first review meeting the set of conditions), the plurality of sets of item attributes may comprise a first set of item attributes, of the first item, associated with the first review. For example, the first set of item attributes may comprise one or more item attributes, of the first item, discussed in the first review. In an example, the first set of item attributes may be determined by analyzing the first review using one or more language processing techniques (e.g., one or more NLP techniques), one or more machine learning techniques and/or other techniques. In an example, the first set of item attributes may be determined based upon the first review and a plurality of item attributes associated with a first item category of the first item. An item category may correspond to a classification of a group of items, such as a group of products and/or services. At least one of “kitchen appliances”, “art supplies”, “coffee and espresso”, “clothing”, “athletic wear”, “electronics”, “landscaping services”, “electronics”, “smartphones”, etc. may be examples of item categories. The plurality of item attributes may comprise item attributes of a pre-defined list associated with the first item category. In some examples, the first review may be analyzed based upon the plurality of item attributes to identify item attributes, of the plurality of item attributes, that are mentioned and/or referred to in the first review, where the identified item attributes are included in the first set of item attributes. In some examples, the first review may be analyzed based upon the plurality of item attributes to identify item attributes, of the plurality of item attributes, that are mentioned and/or referred to in the first review, where the identified item attributes are included in the first set of item attributes. In an example in which the first item is a smartphone, the first set of item attributes (and/or the plurality of item attributes associated with the first item category) may comprise at least one of “screen size”, “display quality”, “battery life”, “short battery life”, “long battery life”, “low quality”, “high quality”, “slow charging”, “fast charging”, “not durable”, “durable”, “stopped working”, “still working”, “user friendliness”, “hard to interact with”, etc.

Alternatively and/or additionally, the first review information may comprise a set of positive attributes of the first item indicated by one or more first reviews of the subset of reviews 224 and/or a set of negative attributes of the first item indicated by one or more second reviews of the subset of reviews 224 (e.g., the one or more first reviews may be the same as or different than the one or more second reviews). In some examples, the positive attributes and/or the negative attributes may be determined based upon the plurality of sets of item attributes. For example, a sentiment (e.g., a sentiment polarity, such as positive or negative) of an item attribute of the plurality of sets of item attributes may be determined, wherein the item attribute is included in the set of positive attributes or is included in the set of negative attributes based upon the sentiment (e.g., if the sentiment is positive, the item attribute is determined to be a positive attribute of the item and is included in the set of positive attributes and/or if the sentiment is negative, the item attribute is determined to be a negative attribute of the item and is included in the set of negative attributes). In an example, the sentiment of the item attribute may be indicated by item attribute information of the item attribute. Alternatively and/or additionally, the sentiment of the item attribute may be determined by analyzing one or more reviews (e.g., one or more reviews that are determined to be associated with the item attribute, such as where the item attribute is included in one or more sets of item attributes, of the plurality of sets of item attributes, associated with the one or more reviews) using one or more language processing techniques (e.g., one or more NLP techniques), one or more machine learning techniques and/or other techniques. For example, text of the one or more reviews (e.g., one or more sentences of the one or more reviews that mention and/or refer to the item attribute) may be analyzed (e.g., via sentiment analysis) to determine a sentiment (e.g., a sentiment polarity) of the text, wherein the sentiment of the item attribute is determined to be the sentiment of the text. Alternatively and/or additionally, one or more positive attributes of the positive attributes and/or one or more negative attributes of the negative attributes may be different than item attributes of the plurality of sets of item attributes. In an example, the one or more positive attributes and/or the one or more negative attributes may be generated by analyzing the first review using one or more language processing techniques (e.g., one or more NLP techniques), one or more machine learning techniques and/or other techniques. In an example, an item attribute of the plurality of sets of item attributes may be modified to generate a positive attribute of the one or more positive attributes and/or a negative attribute of the one or more negative attributes. In an example, the plurality of sets of item attributes may comprise “screen size” corresponding to a screen size of the first item, wherein the one or more negative attributes may comprise “small screen size” based upon the item attribute “screen size” and/or text of a review of the subset of reviews 224 indicating that the screen size of the first item is too small. Alternatively and/or additionally, the first review information may comprise one or more positive attribute review measures associated with the set of positive attributes of the first item and/or one or more negative attribute review measures associated with the set of negative attributes of the first item. In an example, a positive attribute review measure of the one or more positive attribute review measures may be indicative of a measure of reviews, of the subset of reviews 224, that are indicative of a positive attribute of the set of positive attributes of the first item. For example, the positive attribute review measure may correspond to at least one of a quantity of reviews that are indicative of the positive attribute, a proportion of reviews, of the subset of reviews 224, that are indicative of the positive attribute, etc. In an example, a negative attribute review measure of the one or more negative attribute review measures may be indicative of a measure of reviews, of the subset of reviews 224, that are indicative of a negative attribute of the set of negative attributes of the first item. For example, the negative attribute review measure may correspond to at least one of a quantity of reviews that are indicative of the negative attribute, a proportion of reviews, of the subset of reviews 224, that are indicative of the negative attribute, etc.

In some examples, the first review information may comprise a plurality of review scores associated with the subset of reviews 224. A review score of the plurality of review scores may correspond to a quality of a review, such as a value and/or usefulness of the review in assisting a user to make a purchase decision. For example, the plurality of review scores may comprise the first review score associated with the first review of the subset of reviews 224, a second review score associated with a second review of the subset of reviews 224, etc. In an example, review scores of the plurality of review scores (other than the first review score) may be determined using one or more of the techniques provided herein with respect to determining the first review score.

In some examples, the first review information may comprise a first item rating based upon the subset of reviews 224. For example, the first item rating may be based upon ratings of the subset of reviews 224. In an example, one or more operations (e.g., mathematical operations) may be performed using the ratings of the subset of reviews 224 to determine the ratings. In an example, the ratings of the subset of reviews 224 may be averaged to determine the first item rating of the first item. Alternatively and/or additionally, the first item rating may be based upon a plurality of weights associated with the ratings. In an example, the plurality of weights may be based upon the plurality of review scores. For example, the plurality of weights may comprise a first weight associated with the first review and/or a first rating of the first review, wherein the first weight is determined based upon the first review score associated with the first review. For example, the first weight may be a function of the first review score and/or one or more other values, where the first weight may increase with an increase of the first review score. In an example, weights of the plurality of weights (other than the first weight) may be determined using one or more of the techniques provided herein with respect to determining the first weight. In some examples, the first item rating may be determined based upon the ratings of the subset of reviews 224 and the plurality of weights such that, in determining the first item rating, ratings with higher weights of the plurality of weights are emphasized over ratings with lower weights of the plurality of weights. In an example, the first weight associated with the first rating may be higher than a second weight associated with a second rating of the ratings of the subset of reviews 224, and thus, the first rating may be emphasized over the second rating in determining the first item rating. In some examples, one or more operations (e.g., mathematical operations) may be performed using the ratings of the subset of reviews 224 of the first item and/or the plurality of weights associated with the ratings of the subset of reviews 224 to determine the first item rating (such as by determining a weighted mean of the ratings of the subset of reviews 224 using the plurality of weights). It may be appreciated that by determining the first item rating based upon the subset of reviews 224 (that meet the set of conditions, for example) and/or the plurality of weights (based upon the plurality of review scores, for example), the first item rating may be determined more accurately and/or may provide a more useful rating for purposes of making a purchase decision (such as due to using ratings of reviews that are determined to be authentic to determine the first item rating and/or due to applying the plurality of weights such that review scores of the reviews are considered in determining the first item rating).

In some examples, the first review information may comprise a first authentic review report (e.g., a review summary) based upon the subset of reviews 224. In an example, the first authentic review report may be indicative of at least one of one or more item attributes of the first item (e.g., one or more item attributes of the plurality of sets of item attributes), the set of positive attributes, the set of negative attributes, the one or more positive attribute review measures associated with the set of positive attributes, the one or more negative attribute review measures associated with the set of negative attributes, the plurality of review scores, the first item rating, etc.

In some examples, the first review information may be updated. For example, updating the first review information may comprise (i) extracting reviews from the one or more first internet resources (and/or other internet resources), (ii) determining whether or not the reviews meet the set of conditions, (iii) adding one or more reviews, of the reviews, to the subset of reviews 228 based upon the one or more reviews meeting the set of conditions, and/or (iv) in response to adding the one or more reviews to the subset of reviews 228 determining (e.g., updating) the first review information based upon the subset of reviews 228. In an example, the first review information may be updated periodically. In some examples, network activity and/or memory of a server hosting an internet resource of the one or more first internet resources may be monitored to detect data being transmitted to and/or stored on the server. In some examples, attempts to extract review data from the server may be based upon an amount of data transmitted to and/or stored on the server (e.g., an attempt to extract review data may be performed in response to the amount of data meeting a threshold amount of data). In an example, the review system may access data on the server to determine whether or not one or more new reviews associated with the first item are stored in the server (and/or may extract the data from the server based upon identification of one or more new reviews on the server) in response to the amount of data meeting (e.g., exceeding) the threshold amount of data, which may result in reduced network traffic and/or may improve network performance by way of limiting data extraction attempts based upon the amount of data. In some examples, in response to an attempt to extract data from the server, the amount of data may be reset (e.g., to zero), and/or the review system may not perform another attempt to extract data from the server until the amount of data meets the threshold amount of data.

At 112, a first request for review information may be received from a first client device. The first client device may be at least one of a phone, a smartphone, a laptop, a tablet, a computer, etc. In some examples, the first request is received in association with the first client device accessing a third internet resource and/or requesting to access the third internet resource. For example, the first request may be transmitted (by the first client device) in response to (e.g., upon and/or during) the first client device accessing the third internet resource. Alternatively and/or additionally, the first request may be transmitted (by the first client device) in response to (e.g., upon and/or during) the first client device requesting to access the third internet resource (e.g., the first client device requesting to access the third internet resource may comprise the first client device transmitting a request, to a server associated with the third internet resource, to access the third internet resource). Alternatively and/or additionally, the first request may correspond to the request, transmitted by the first client device, to access the third internet resource.

In some examples, the first request may be transmitted using a software module (e.g., using a program of the software module comprising processor executable instructions) comprising at least one of an application (e.g., at least one of a mobile application, web application, etc.), a browser, a browser extension, a browser plugin, etc. For example, the software module may be installed on the first client device (e.g., in a scenario in which the software module is a browser extension and/or a browser plugin, the software module may interact with the browser of the first client device). In an example, the software module may be used to identify the first client device accessing the third internet resource and/or requesting to access the third internet resource. For example, the first client device may access the third internet resource and/or request to access the third internet resource in response to an input received via a graphical user interface of the first client device, such as an interface of at least one of an application, the browser, etc. In an example, the input may be detected (e.g., using the software module) and in response to detecting the input, the first request for review information may be transmitted. Alternatively and/or additionally, one or more transmissions and/or one or more receptions of the first client device (e.g., one or more transmissions and/or one or more receptions performed using the application and/or the browser of the first client device) may be monitored (e.g., using the software module). In an example, the first request may be transmitted in response to identifying (e.g., using the software module) one or more transmissions to a server associated with the third internet resource (e.g., a server that hosts the third internet resource) and/or one or more receptions from a server associated with the third internet resource (e.g., a server that hosts the third internet resource). In an example, the first request identifies the third internet resource. For example, the first request may comprise an indication of a web address (e.g., a Uniform Resource Locator (URL)) of the third internet resource. In some examples, the web address may be determined and/or included in the first request (e.g., using the software module) based upon the input, the one or more transmissions and/or the one or more receptions.

At 114, it is determined that the first request is associated with the first item. In an example, the determination that the first request is associated with the first item may correspond to a determination that the first request is a request for review information associated with the first item. In some examples, it may be determined that the first request is associated with the first item based upon information associated with the third internet resource (e.g., the third internet resource may be identified based upon the web address of the third internet resource indicated by the first request) and the first item identification information associated with the first item. In an example, the information associated with the third internet resource may comprise content of the third internet resource. It may be determined, based upon the information associated with the third internet resource and the first item identification information associated with the first item, that the third internet resource is associated with the first item, wherein the determination that the first request is associated with the first item is based upon the determination that the third internet resource is associated with the first item. In an example, it may be determined that the third internet resource is a shopping internet resource associated with selling the first item. For example, the third internet resource may belong to a third shopping platform (e.g., the third internet resource may correspond to a web page, of the third shopping platform, where the first item can be purchased). In an example, it may be determined that the third internet resource is associated with the first item based upon a determination that at least one of an item name indicated by the third internet resource matches the first item name of the first item, an item identifier indicated by the third internet resource matches the first item identifier of the first item, a UPC indicated by the third internet resource matches the first UPC of the first item, etc., wherein the first item name, the first item identifier and/or the first UPC are determined based upon the first item identification information.

At 116, in response to determining that the first request is associated with the first item, an authentic review interface, comprising one or more graphical objects indicative of the first review information associated with the first item, may be displayed via the first client device. In an example, the one or more graphical objects of the authentic review interface may comprise at least one of text, one or more pictures, one or more images, one or more symbols, one or more links, etc. In an example, the authentic review interface may be displayed in conjunction with content of the third internet resource. In some examples, the graphical user interface of the first client device may be controlled to display the authentic review interface, such as in addition to displaying content of the third internet resource. For example, an interface displaying content of the third internet resource may be augmented by displaying a graphical object of the one or more graphical objects of the authentic review interface adjacent to (e.g., at least one of over, under, to the side of, between, etc.) the content of the third internet resource. For example, a graphical object of the one or more graphical objects of the authentic review interface may be displayed between first content of the third internet resource and second content of the third internet resource. Alternatively and/or additionally, a graphical object of the one or more graphical objects of the authentic review interface may be displayed overlaying content of the third internet resource. In an example, whereas merely content of the third internet resource may be displayed on client devices that do not implement one or more of the techniques of the present disclosure, according to one or more embodiments herein, the graphical user interface may be controlled (e.g., using the software module) to display a graphical object, of the one or more graphical objects of the authentic review interface, in addition to content of the third internet resource, such as where the graphical object of the authentic review interface is displayed between first content of the third internet resource and second content of the third internet resource. For example, an interface displayed by the first client device when the third internet resource is accessed may comprise an augmented version, of the third internet resource, that comprises content of the third internet resource and a graphical object of the one or more graphical objects of the authentic review interface.

FIGS. 2D-2H illustrate the first client device (shown with reference number 200) displaying the one or more graphical objects of the authentic review interface, according to some exemplary embodiments. In an example, the authentic review interface and/or content of the third internet resource may be displayed via the browser (shown with reference number 240) of the first client device 200. The browser 240 may comprise an address bar 260 comprising a web address (e.g., a URL) of the third internet resource.

FIG. 2D illustrates one or more first graphical objects 230 of the authentic review interface and/or content of the third internet resource being displayed via the first client device 200, according to some exemplary embodiments. In an example, an interface displayed by the first client device 200 in response to accessing the third internet resource may comprise an augmented version, of the third internet resource, that comprises content of the third internet resource and the one or more first graphical objects 230 of the authentic review interface. In the example shown in FIG. 2D, the first item may correspond to a box of baby diapers. In an example, the one or more first graphical objects 230 may be displayed between first content 226 of the third internet resource and second content 228 of the third internet resource. For example, the first content 226 may comprise an indication 232 of an item name of the first item, an indication 250 of a rating (determined based upon ratings of reviews on the third internet resource), an indication of a quantity of ratings (e.g., 2,560 ratings) on the third internet resource, an indication 248 of a number of answered questions, etc. Alternatively and/or additionally, the second content 228 may comprise at least one of an indication 254 of a price of the first item, a purchase selectable input 256 associated with purchasing the first item, an add to cart selectable input 258 associated with the adding the first item to a shopping cart associated with the third shopping platform, one or more item specifications of the first item, etc. Alternatively and/or additionally, the one or more first graphical objects 230 may be displayed adjacent to (e.g., to the side of) an image 252 (e.g., an image of the first item) of the third internet resource.

In some examples, the one or more first graphical objects 230 may comprise an indication 242 of a review score associated the subset of reviews 224 (e.g., the review score may be determined based upon the plurality of review scores, such as by averaging the plurality of review scores), an indication 244 of the first item rating (e.g., 3.5 out of 5 represented by 3 filled stars, one half-filled star and one empty star) and/or an indication 246 of a quantity of reviews of the subset of reviews 224 (e.g., 36 reviews, wherein the indication 246 may be indicative of the subset of reviews 224 being certified as authentic and/or high quality by the review system).

FIG. 2E illustrates one or more second graphical objects 274 of the authentic review interface and/or content of the third internet resource being displayed via the first client device 200, according to some exemplary embodiments. In an example, an interface displayed by the first client device 200 in response to accessing the third internet resource may comprise an augmented version, of the third internet resource, that comprises content of the third internet resource and the one or more second graphical objects 274 of the authentic review interface. In the example shown in FIG. 2E, the first item may correspond to a box of baby diapers. In an example, the one or more second graphical objects 274 may be displayed between the first content 226 of the third internet resource and the second content 228 of the third internet resource. Alternatively and/or additionally, the one or more second graphical objects 274 may be displayed adjacent to (e.g., to the side of) the image 252 of the third internet resource.

In some examples, the one or more second graphical objects 274 may comprise a list of prices 266 indicative of prices, of the first item, indicated by other internet resources associated with other shopping platforms other than the third shopping platform. The prices indicated by the list of prices 266 may be determined based upon prices, of the first item, indicated by internet resources of the one or more first internet resources (and/or other internet resources). For example, the one or more first internet resources (and/or other internet resources associated with selling the first item) may be analyzed to identify prices of the first item for inclusion in the list of prices 266. In an example, the list of prices may comprise an indication of a price (e.g., $39.99) of the first item as indicated by an internet resource, and an indication of a shopping platform (e.g., “jensenhome.value”) comprising the internet resource, wherein the indication of the shopping platform may comprise a link to the internet resource such that in response to a selection of the indication of the shopping platform, the internet resource may be accessed by the first client device 200. Accordingly, based upon the list of prices 266, a user may conveniently decide which shopping platform to use for purchasing the first item based upon price. Alternatively and/or additionally, the one or more second graphical objects may comprise an indication 270 of the first item rating (e.g., true global rating) and/or an indication 272 of the quantity of reviews of the subset of reviews 224.

FIG. 2F illustrates the first authentic review report 282 being displayed via the first client device 200, according to some exemplary embodiments. In an example, an interface displayed by the first client device 200 in response to accessing the third internet resource may comprise an augmented version, of the third internet resource, that comprises content of the third internet resource and the first authentic review report 282 of the authentic review interface. In some examples, the first authentic review report 282 may be positioned below at least one of the first content 226 of the third internet resource, the one or more first graphical objects 230, the one or more second graphical objects 274, the second content 228 of the third internet resource, etc. For example, the interface displayed by the first client device 200 may provide for scrolling upwards and/or downwards (and/or to the side) throughout content of the third internet resource and/or throughout graphical objects of the authentic review interface. In an example, the interface may be scrolled downwards, from the view shown in FIG. 2D and/or FIG. 2E to reach the view of the first authentic review report 282 shown in FIG. 2F. Alternatively and/or additionally, the interface may display the view of the first authentic review report 282 shown in FIG. 2F in response to a selection of a selectable input. In an example, the one or more first graphical objects 230 and/or the one or more second graphical objects 274 may comprise the selectable input. In an example, the selectable input may correspond to an indication of the one or more first graphical objects 230 and/or the one or more second graphical objects 274 and/or other selectable input of the authentic review interface.

In some examples, the first authentic review report 282 may comprise an indication 278 of the first item rating and/or an indication 280 of the review score associated the subset of reviews 224. Alternatively and/or additionally, the first authentic review report 282 may comprise a general summary 284 comprising text indicative of one or more metrics associated with ratings indicated by reviews of the subset of reviews 224, such as at least one of a measure of reviews of the subset of reviews 224 that have 5-star ratings (e.g., 33% of the subset of reviews 224 are indicative of a 5-star rating) and/or a measure of reviews of the subset of reviews 224 that have 1-star ratings (e.g., 31% of the subset of reviews 224 are indicative of a 1-star rating). In some examples, the text of the general summary 284 may be generated based upon ratings of the subset of reviews 224 (e.g., metrics indicated by the general summary 284 may be determined based upon the ratings of the subset of reviews 224) and/or may be generated using one or more language processing techniques (e.g., one or more NLP techniques), one or more machine learning techniques and/or other techniques.

Alternatively and/or additionally, the first authentic review report 282 may comprise a negative attribute summary 286 comprising text indicative of negative attributes of the set of negative attributes (of the first item) indicated by the subset of reviews 224 and/or one or more metrics associated with the negative attributes. For example, the negative attribute summary 286 may be indicative of a negative attribute (e.g., no frontal tape) of the set of negative attributes and/or a negative attribute review measure associated with the negative attribute (e.g., the negative attribute review measure may indicate that 43% of reviews of the subset of reviews 224 mention and/or refer to the negative attribute corresponding to the first item having no frontal tape). In some examples, the negative attributes and/or the one or more metrics indicated by the negative attribute summary 286 may be determined based upon the set of negative attributes, the one or more negative attribute review measures and/or the subset of reviews 224, wherein the text of the negative attribute summary 286 may be generated using one or more language processing techniques (e.g., one or more NLP techniques), one or more machine learning techniques and/or other techniques.

Alternatively and/or additionally, the first authentic review report 282 may comprise a positive attribute summary 288 comprising text indicative of positive attributes of the set of positive attributes (of the first item) indicated by the subset of reviews 224 and/or one or more metrics associated with the positive attributes. For example, the positive attribute summary 288 may be indicative of a positive attribute (e.g., environmental friendliness) of the set of positive attributes and/or a positive attribute review measure associated with the positive attribute (e.g., the positive attribute review measure may indicate that 57% of reviews of the subset of reviews 224 mention and/or refer to the positive attribute comprising the first item being environmentally friendly). In some examples, the positive attributes and/or the one or more metrics indicated by the positive attribute summary 288 may be determined based upon the set of positive attributes, the one or more positive attribute review measures and/or the subset of reviews 224, wherein the text of the positive attribute summary 288 may be generated using one or more language processing techniques (e.g., one or more NLP techniques), one or more machine learning techniques and/or other techniques.

Alternatively and/or additionally, the first authentic review report 282 may comprise a time-based summary 290 comprising text indicative of one or more metrics associated with ratings indicated by reviews of the subset of reviews 224 over one or more periods of time. For example, the time-based summary 290 may be indicative of a measure of reviews, among reviews (of the subset of reviews 224) that are posted during a first period of time (e.g., the last 6 months), that have 1-star and/or 2-star ratings (e.g., 72% of reviews, of the subset of reviews 224, that are posted during the first period of time are indicative of a 1-star and/or 2-star rating). Alternatively and/or additionally, the time-based summary 290 may be indicative of a measure of reviews, among reviews (of the subset of reviews 224) that are posted during the first period of time, that have 4-star and/or 5-star ratings (e.g., 22% of reviews, of the subset of reviews 224, that are posted during the first period of time are indicative of a 4-star and/or 5-star rating). In some examples, the one or more metrics indicated by the time-based summary 290 may be determined based upon ratings of the subset of reviews 224, times of reviews of the subset of reviews 224 and/or the subset of reviews 224, wherein the text of the time-based summary 290 may be generated using one or more language processing techniques (e.g., one or more NLP techniques), one or more machine learning techniques and/or other techniques.

Alternatively and/or additionally, the first authentic review report 282 may comprise a list of attributes 292 (e.g., a list of positive attributes and/or negative attributes of the first item) indicative of positive attributes of the first item, negative attributes of the first item and/or one or more metrics associated with the positive attributes and/or the negative attributes. Alternatively and/or additionally, the list of attributes 292 may comprise metrics associated with the positive attributes and/or the negative attributes (e.g., the list of attributes 292 may comprise an indication that 28% of the subset of reviews 224 mention and/or refer to a negative attribute comprising skin-friendliness and/or skin issues). Alternatively and/or additionally, the list of attributes 292 may comprise one or more pictures and/or symbols (e.g., an emoji, a check-mark, etc.) to indicate whether or not an attribute in the list is a positive attribute or a negative attribute. In some examples, the positive attributes, the negative attributes and/or the one or more metrics indicated by the list of attributes 292 may be generated based upon the set of positive attributes, the positive attribute review measures, the set of negative attributes, the negative attribute review measures and/or the subset of reviews 224, wherein the text of the positive attribute summary 288 may be generated using one or more language processing techniques (e.g., one or more NLP techniques), one or more machine learning techniques and/or other techniques.

Alternatively and/or additionally, the first authentic review report 282 may comprise an indication 294 that the first item is not a certified item (e.g., the first item is not certified by the review system). For example, the first item may not be certified by the review system based upon a determination that the first item rating is less than a threshold rating for certification.

In some examples, the first authentic review report 282 may comprise a set of images and/or videos 296. In some examples, the set of images and/or videos 296 may be selected from reviews of the subset of reviews 224 and/or other reviews of the first plurality of reviews 210. For example, the set of images and/or videos 296 may be posted with reviews of the subset of reviews 224 and/or other reviews of the first plurality of reviews 210. In some examples, the set of images and/or videos 296 may be selected from a plurality of images and/or videos (e.g., a plurality of images and/or videos comprises images and/or videos of the subset of reviews 224 and/or images and/or videos of the first plurality of reviews 210) based upon a determination that the set of images and/or videos 296 are more valuable and/or useful than other images and/or videos of the plurality of images and/or videos in assisting a user to make a purchase decision, which may be determined based upon at least one of quantities of positive reactions to images and/or videos of the plurality of images and/or videos, quantities of negative reactions to images and/or videos of the plurality of images, etc., and/or may be determined by analyzing the plurality of images and/or videos using one or more image analysis techniques, one or more machine learning techniques and/or other techniques.

FIG. 2G illustrates the first authentic review report 282 being displayed via the first client device 200, according to some exemplary embodiments. In the example shown in FIG. 2G, the first item may be a smartphone. In an example, the first authentic report 282 may comprise a graphical object 203 (e.g., a chart, such as a pie chart) indicative of measures of reviews of the subset of reviews 224 associated with different sentiments (e.g., positive, negative and neutral). For example, the graphical object 203 may be indicative of a measure of negative reviews of the subset of reviews 224 (e.g., 35% of the subset of reviews 224), a measure of positive reviews of the subset of reviews 224 (e.g., 52% of the subset of reviews 224) and/or a measure of neutral reviews of the subset of reviews 224 (e.g., 13% of the subset of reviews 224). In an example, a review may be analyzed (e.g., via sentiment analysis) to determine a sentiment of the review. Alternatively and/or additionally, a sentiment of a review may be determined based upon a rating of the review. For example, if the rating of the review corresponds to a rating of one or more first ratings (e.g., 1-start rating and/or 2-star rating), the sentiment of the review may be determined to be negative. Alternatively and/or additionally, if the rating of the review corresponds to a rating of one or more second ratings (e.g., 3-star rating), the sentiment of the review may be determined to be neutral. Alternatively and/or additionally, if the rating of the review corresponds to a rating of one or more second ratings (e.g., 4-star rating and/or 5-star rating), the sentiment of the review may be determined to be positive. Alternatively and/or additionally, the first authentic report 282 may comprise a list of negative attributes 205 of the first item and/or a list of positive attributes 207 of the first item.

FIG. 2H illustrates a list of reviews 229, comprising reviews of the subset of reviews 224, being displayed via the first client device 200, according to some exemplary embodiments. In an example, an interface displayed by the first client device 200 in response to accessing the third internet resource may comprise an augmented version, of the third internet resource, that comprises content of the third internet resource and the list of reviews 229 of the authentic review interface. In some examples, the list of reviews 229 may be positioned below at least one of the first content 226 of the third internet resource, the one or more first graphical objects 230, the one or more second graphical objects 274, the second content 228 of the third internet resource, the first authentic review report 282, etc. In an example, the interface may be scrolled downwards, from the view shown in FIG. 2D, FIG. 2E, FIG. 2F and/or FIG. 2G to reach the view of the list of reviews 229 shown in FIG. 2H. Alternatively and/or additionally, the interface may display the view of the list of reviews 229 shown in FIG. 2H in response to a selection of a selectable input. In an example, the one or more first graphical objects 230 and/or the one or more second graphical objects 274 may comprise the selectable input. In an example, the selectable input may correspond to an indication (e.g., the indication 246 shown in FIG. 2D and/or the indication 272 shown in FIG. 2E may correspond to the selectable input) of the one or more first graphical objects 230 and/or the one or more second graphical objects 274 and/or other selectable input of the authentic review interface.

Alternatively and/or additionally, embodiments are contemplated in which the first authentic review report 282 and/or the list of reviews 229 may be displayed independently from (e.g., without displaying) the third internet resource. In an example, a fourth internet resource (e.g., different than the third internet resource) comprising the first authentic review report 282 and/or the list of reviews 229 may be accessed and/or displayed in response to a selection of a selectable input. In an example, the one or more first graphical objects 230 and/or the one or more second graphical objects 274 may comprise the selectable input. In an example, the selectable input may correspond to an indication (e.g., the indication 246 shown in FIG. 2D and/or the indication 272 shown in FIG. 2E may correspond to the selectable input) of the one or more first graphical objects 230 and/or the one or more second graphical objects 274 and/or other selectable input of the authentic review interface.

In some examples, the authentic review interface may comprise a selectable input 215 associated with sorting the list of reviews 229 based upon review scores associated with the subset of reviews 224. In an example, based upon a selection of the selectable input 215, an order in which reviews are displayed in the list of reviews 229 may be based upon the plurality of review scores. For example, a review associated with a higher review score of the plurality of review scores may be displayed at least one of above, before, etc. a review associated with a lower review score of the plurality of review scores. Alternatively and/or additionally, the authentic review interface may comprise a selectable input 217 associated with sorting the list of reviews 229 based upon times associated with the subset of reviews 224. In an example, based upon a selection of the selectable input 217, an order in which reviews are displayed in the list of reviews 229 may be based upon times in which reviews of the subset of reviews 224 are posted. For example, a review posted at a first time may be displayed at least one of above, before, etc. a review posted at a second time prior to the first time.

In some examples, the list of reviews 229 may comprise indications of at least one of review scores associated with reviews of the subset of reviews 224, item attributes associated with reviews of the subset of reviews 224, ratings of reviews of the subset of reviews 224, timestamps associated with reviews of the subset of reviews 224, etc.

In an example, the list of reviews 229 may comprise a review 227 of the subset of reviews 224, an indication 223 of a rating of the review 227, an indication 225 of a timestamp of the review 227 (e.g., a date in which the review 227 was posted), and/or indications 221 (e.g., tags) of a set of item attributes, of the first item, discussed in the review 227. In some examples, the indications 221 may correspond to selectable inputs. In an example, in response to a selection of an indication 221 of an item attribute (e.g., a tag), one or more reviews that discuss the same item attribute may be identified and/or displayed via the first client device 200.

In an example, the subset of reviews 224 comprises reviews (of the first item) from internet resources of a plurality of platforms (e.g., shopping platforms and/or reviewing platforms, wherein platforms of the plurality of platforms may be different from each other). In some examples, the third shopping platform comprising the third internet resource may be different than one, some and/or all of the plurality of platforms. Alternatively and/or additionally, the third shopping platform may be the same as a shopping platform of the plurality of platforms. By including reviews from platforms other than the third shopping platform in the subset of reviews 224 and/or by displaying the authentic review interface (comprising the subset of reviews 224 and/or indications of the first review information) in conjunction with the third internet resource, reviews and review information that would otherwise be inaccessible to a user accessing the third internet resource are automatically made available for the user to view and use to make a purchase decision in response to accessing the third internet resource. Accordingly, the user may not be required to navigate throughout the internet to find different reviews of the first item that are not available on the third internet resource (since the authentic review interface comprising reviews from the plurality of platforms may be automatically displayed in association with display of content of the third internet resource when the third internet resource is accessed).

In an example, the subset of reviews 224 comprises reviews (of the first item) from one or more internet resources of a single platform (e.g., a single shopping platform or a single reviewing platform). In some examples, the third shopping platform comprising the third internet resource may be different than the single reviewing platform. Alternatively and/or additionally, the third shopping platform may be the same as the single platform.

Alternatively and/or additionally, the authentic review interface may be displayed separately from the third internet resource. For example, the authentic review interface may be displayed via a webpage and/or application (e.g., a standalone webpage and/or application) associated with the review system. In an example, the authentic review interface comprising one or more graphical objects indicative of the first review information may be accessed and/or displayed via the webpage and/or application associated with the review system.

Alternatively and/or additionally, the first request may be received via a review system platform (e.g., an application and/or a website associated with the review system). For example, the first request may comprise information input via a review system interface associated with the review system platform and/or the review system. The first request may be transmitted by the first client device 200 in response to the information being input via the review system interface. For example, the information input via the review system interface may comprise at least one of a web address of an internet resource of a shopping platform (e.g., a web address of the third internet resource) and/or item identification information (e.g., at least one of an item name, an item identifier, a UPC, etc. of an item). In an example, the first request may be determined to be associated with the first item based upon the web address and/or the item identification information input via the review system interface (such as using one or more of the techniques provided herein). In some examples, the review system interface may display the authentic review interface comprising one or more graphical objects indicative of the first review information (such as using one or more of the techniques provided herein) in response to determining that the first request is associated with the first item. In an example in which the information input via the review system interface identifies the third internet resource, in response to determining that the first request is associated with the first item, the review system interface may display the authentic review interface comprising one or more graphical objects indicative of the first review information in conjunction with the third internet resource (such as using one or more of the techniques provided herein, such as one or more of the techniques discussed with respect to FIGS. 2D-2H). Alternatively and/or additionally, in response to determining that the first request is associated with the first item, the review system interface may display the authentic review interface comprising one or more graphical objects indicative of the first review information independently from (e.g., without displaying) the third internet resource.

Alternatively and/or additionally, the information input via the review system interface may comprise a first image captured via a camera (e.g., a camera of the first client device 200, such as a smartphone or other type of client device with a camera). In an example, the first image may be captured when a user of the first client device 200 is shopping at a store and/or wants to view reviews and/or review information associated with an item at the store. Item information may be generated based upon the first image (e.g., the item information may be generated using one or more image processing techniques). In an example, the first image may comprise a view of the item and/or the item information may be indicative of one or more visual characteristics of the item in the first image. In an example, the item information may be analyzed and/or compared with item identification information indicative of visual characteristics of a plurality of items to determine that the item in the first image is the first item (e.g., it may be determined that the first request is associated with the first item based upon the determination that the item in the first image is the first item). Alternatively and/or additionally, the first image may comprise a view of at least one of a barcode, a UPC, etc. The item information generated based upon the first image may comprise an indication of at least one of the barcode, the UPC, etc. In an example, the item information may be compared with item identification information indicative of barcodes and/or UPCs of a plurality of items to determine that the barcode and/or the UPC correspond to the first item, such as based upon the first item identification information associated with the first item (e.g., it may be determined that the first request is associated with the first item based upon the determination that the barcode and/or the UPC correspond to the first item).

In some examples, one or more reviews of the subset of reviews 224 may be determined and/or collected using one or more of the techniques provided in U.S. Patent Application Publication US-2021-0357994-A1, published Nov. 18, 2021, which is incorporated herein by reference in its entirety. For example, the one or more reviews of the subset of reviews 224 may be determined and/or collected using one or more of the techniques provided with respect to the example method 100 of FIG. 1 of U.S. Patent Application Publication US-2021-0357994-A1. In some examples, the one or more reviews may be automatically determined to meet the set of conditions for inclusion in the subset of reviews 224 (and/or the one or more reviews may be automatically included in the subset of reviews 224 without determining whether or not the one or more reviews meet the set of conditions). In the event of inconsistent usages between the present disclosure and U.S. Patent Application Publication US-2021-0357994-A1, the usage in the U.S. Patent Application Publication US-2021-0357994-A1 should be considered supplementary to that of the present disclosure; for irreconcilable inconsistences, the usage in the present disclosure controls.

It may be appreciated that the disclosed subject matter may assist a user in viewing authentic and/or accurate reviews associated with items such that the user can more accurately determine a quality of an item using the reviews and/or make an informed decision on whether or not to purchase the item. Alternatively and/or additionally, it may be appreciated that the disclosed subject matter may assist a user in more quickly and/or conveniently identifying main points of the subset of reviews 228 by generating the authentic review report 282 that may summarize information from the subset of reviews 228, such as by way of providing main points of the subset of reviews 228 (e.g., the main points may correspond to at least one of item attributes discussed in the subset of reviews 228, positive attributes discussed in the subset of reviews 228, negative attributes discussed in the subset of reviews 228, metrics associated with the subset of reviews 228, etc.) that may assist a user in more conveniently make an informed purchase decision

Implementation of at least some of the disclosed subject matter may lead to benefits including, but not limited to, providing authentic and/or more useful reviews (e.g., as a result of extracting reviews from one or more internet resources, as a result of selecting the subset of reviews 228 based upon the subset of reviews meeting the set of conditions to ensure that the subset of reviews 228 are authentic, higher quality and more useful for making informed decisions on whether or not to purchase an item, etc.).

It may be appreciated that filtering through inauthentic reviews among a large amount (e.g., thousands) of reviews may prove difficult for a user due to the large amount of time it takes to identify each inauthentic review and/or due to the large amount of reviews (and/or the large amount of inauthentic reviews among the reviews). For example, it may not be unusual for the user to mistake one or more inauthentic reviews for authentic reviews. The user may then make a purchase decision based upon the one or more inauthentic reviews, wherein the purchase decision may be different from what the user would have decided if the user could identify authentic reviews and make the purchase decision based upon the authentic reviews. As provided herein, the subset of reviews 288 that are determined to be authentic and/or meet the threshold review score may be automatically displayed to the user (when the user accesses the third internet resource, for example). Thus, the speed and/or accuracy with which the user can identify authentic reviews and/or make a decision may be improved. Alternatively and/or additionally, as a result of displaying the authentic review report 282 (in conjunction with the third internet resource, for example), the user may more quickly and/or conveniently identify the main points of the subset of reviews 228 and/or more quickly and/or conveniently make a purchase decision of whether or not to purchase an item.

Alternatively and/or additionally, implementation of at least some of the disclosed subject matter may lead to benefits including a reduction in screen space and/or an improved usability of a display of the first client device 200 (e.g., as a result of generating the authentic review report 282 and/or displaying the authentic review report 282 such that indications of main points of the subset of reviews 228 may automatically be displayed via the first client device 200, etc.).

Alternatively and/or additionally, implementation of at least some of the disclosed subject matter may lead to benefits including a reduction in screen space and/or an improved usability of a display of the first client device 200 (e.g., as a result of displaying graphical objects of the authentic review interface in conjunction with the third internet resource, wherein reviews from internet resources other than the third internet resource may be included in the subset of reviews 228, wherein the first review information comprising the subset of reviews 228 and/or the authentic review report 282 is provided to a user automatically while the third internet resource is accessed such that the user does not need to navigate throughout the internet to find authentic reviews from other sources other than the third internet resource, etc.).

Alternatively and/or additionally, implementation of at least some of the disclosed subject matter may lead to benefits including increasing an accuracy and/or precision in transmitting requested and/or desired content to the first client device 200 and/or presenting the requested and/or desired content to a user of the first client device 200 (e.g., as a result of enabling the first client device 200 to display the first item rating, the authentic review report 282 and/or the subset of reviews 228 such that the user may more quickly and/or conveniently consume authentic reviews of the subset of reviews 228 without having to read through authentic and inauthentic reviews, identify main points of the subset of reviews using the authentic review report 282 and/or make a purchase decision of whether or not to purchase an item).

Alternatively and/or additionally, implementation of at least some of the disclosed subject matter may lead to benefits including, but not limited to, increased generalized revenue (e.g., as a result of presenting authentic reviews with higher quality and/or having greater value and/or usefulness in assisting a user to make a purchase decision, without presenting reviews that are not authentic and without presenting reviews that are left by reviewers merely to receive compensation for the reviews, such that buyers may spend more due to an increase in trust of the reviews).

Alternatively and/or additionally, implementation of at least some of the disclosed subject matter may lead to benefits including less manual effort (e.g., as a result of generating and/or providing the first review information automatically, wherein the user does not need to read through reviews on the third internet resource and/or other internet resources to identify authentic reviews and/or identify main points of the authentic reviews).

In some examples, at least some of the disclosed subject matter may be implemented on a client device, and in some examples, at least some of the disclosed subject matter may be implemented on a server (e.g., hosting a service accessible via a network, such as the Internet).

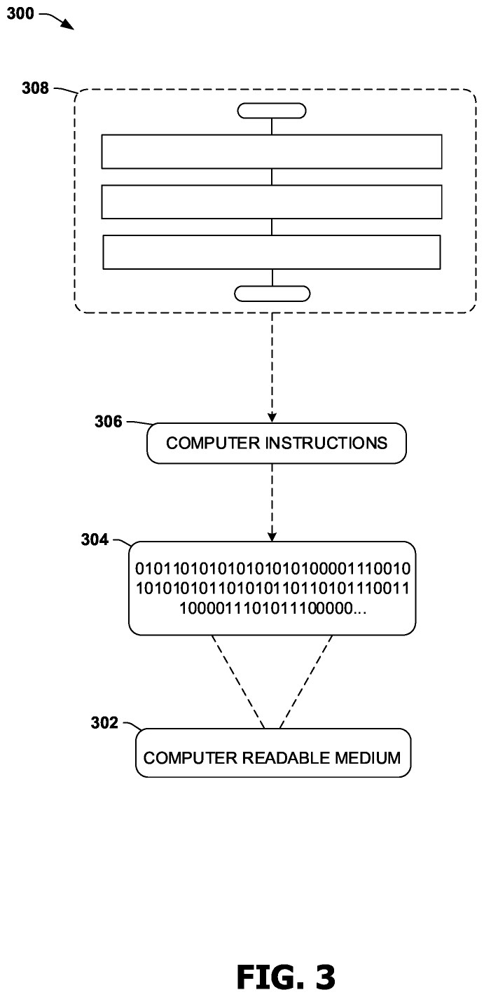

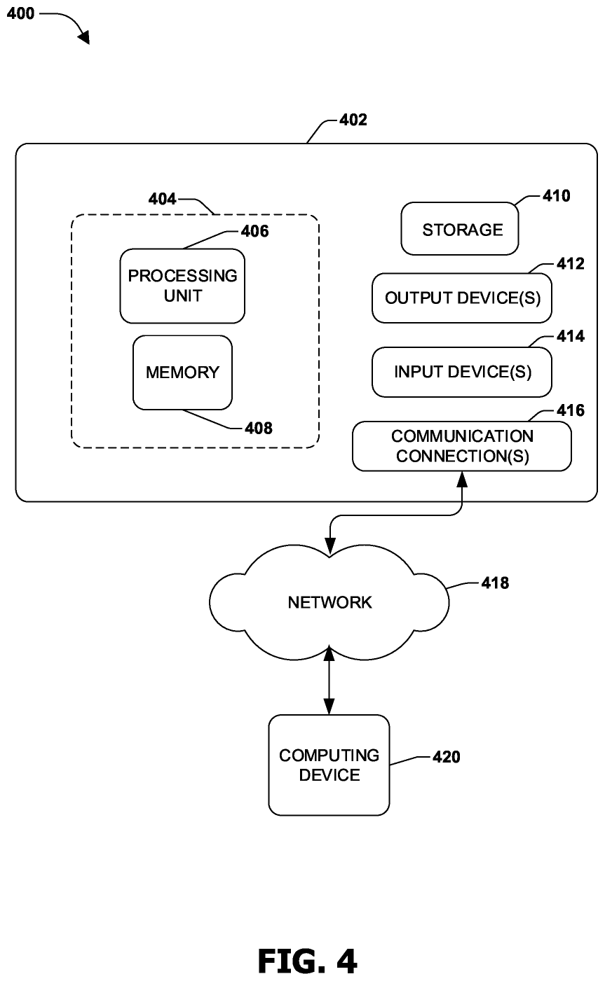

Another embodiment involves a computer-readable medium comprising processor-executable instructions. The processor-executable instructions may be configured to implement one or more of the techniques presented herein. An exemplary computer-readable medium that may be devised in these ways is illustrated in FIG. 3. An implementation 300 may comprise a computer-readable medium 302 (e.g., a CD, DVD, or at least a portion of a hard disk drive), which may comprise encoded computer-readable data 304. The computer-readable data 304 comprises a set of computer instructions 306 configured to operate according to one or more of the principles set forth herein. In one such embodiment 300, the processor-executable computer instructions 306 may be configured to perform a method, such as at least some of the exemplary method 100 of FIG. 1, for example. In another such embodiment, the processor-executable instructions 306 may be configured to implement a system, such as at least some of the exemplary system 201 of FIGS. 2A-2H, for example. Many such computer-readable media 302 may be devised by those of ordinary skill in the art that are configured to operate in accordance with the techniques presented herein. FIG. 4 and the following discussion provide a description of a suitable computing environment to implement embodiments of one or more of the provisions set forth herein. The operating environment of FIG. 4 is just one example of a suitable operating environment and is not intended to indicate any limitation as to the scope of use or functionality of the operating environment. Example computing devices include, but are not limited to, server computers, mainframe computers, personal computers, hand-held or laptop devices, mobile devices (such as mobile phones, Personal Digital Assistants (PDAs), media players, and the like), consumer electronics, multiprocessor systems, mini computers, distributed computing environments that include any of the above systems or devices, and the like.

Although not required, embodiments are described in the general context of “computer readable instructions” being executed by one or more computing devices. Computer readable instructions may be distributed using computer readable media (discussed below). Computer readable instructions may be implemented as programs and/or program modules, such as functions, objects, Application Programming Interfaces (APIs), data structures, and the like, that execute particular tasks or implement particular abstract data types. Typically, the functionality of the computer readable instructions may be combined or distributed (e.g., as desired) in various environments.

FIG. 4 illustrates an example of a system 400 comprising a (e.g., computing) device 402. Device 402 may be configured to implement one or more embodiments provided herein. In an exemplary configuration, device 402 includes at least one processing unit 406 and at least one memory 408. Depending on the configuration and type of computing device, memory 408 may be volatile (such as RAM, for example), non-volatile (such as ROM, flash memory, etc., for example), or some combination of volatile and non-volatile. This configuration is illustrated in FIG. 4 by dashed line 404.

In other embodiments, device 402 may include additional features and/or functionality. For example, device 402 may further include additional storage (e.g., removable and/or non-removable) including, but not limited to, magnetic storage, optical storage, and the like. Such additional storage is illustrated in FIG. 4 by storage 410. In one embodiment, computer readable instructions to implement one or more embodiments provided herein may be in storage 410. Storage 410 may further store other computer readable instructions to implement an application program, an operating system, and the like. Computer readable instructions may be loaded in memory 408 for execution by processing unit 406, for example.

The term “computer readable media” as used herein includes computer storage media. Computer storage media includes volatile and/or nonvolatile, removable and/or non-removable media implemented in any method or technology for storage of information such as computer readable instructions or other data. Memory 408 and storage 410 are examples of computer storage media. Computer storage media may include, but is not limited to including, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store desired information and can be accessed by device 402. Any such computer storage media may be part of device 402.

Device 402 may further include communication connection(s) 416 that allows device 402 to communicate with other devices. Communication connection(s) 416 may include, but is not limited to including, a modem, a radio frequency transmitter/receiver, an integrated network interface, a Network Interface Card (NIC), a USB connection, an infrared port, or other interfaces for connecting device 402 to other computing devices. Communication connection(s) 416 may include a wireless connection and/or a wired connection. Communication connection(s) 416 may transmit and/or receive communication media.

The term “computer readable media” may include, but is not limited to including, communication media. Communication media typically embodies computer readable instructions and/or other data in a “modulated data signal” such as a carrier wave or other transport mechanism and includes any information delivery media. The term “modulated data signal” may correspond to a signal that has one or more of its characteristics set or changed in such a manner as to encode information in the signal.

Device 402 may include input device(s) 414 such as mouse, keyboard, voice input device, pen, infrared cameras, touch input device, video input devices, and/or any other input device. Output device(s) 412 such as one or more displays, speakers, printers, and/or any other output device may also be included in device 402. Input device(s) 414 and output device(s) 412 may be connected to device 402 using a wireless connection, wired connection, or any combination thereof. In one embodiment, an input device or an output device from another computing device may be used as input device(s) 414 or output device(s) 412 for device 402.

Components of device 402 may be connected by various interconnects (e.g., such as a bus). Such interconnects may include a Peripheral Component Interconnect (PCI), such as a Universal Serial Bus (USB), PCI Express, an optical bus structure, firewire (IEEE 1394), and the like. In another embodiment, components of device 402 may be interconnected by a network. In an example, memory 408 may be comprised of multiple (e.g., physical) memory units located in different physical locations interconnected by a network.

Storage devices utilized to store computer readable instructions may be distributed across a network. For example, a computing device 420 accessible using a network 418 may store computer readable instructions to implement one or more embodiments provided herein. Device 402 may access computing device 420 and download a part or all of the computer readable instructions for execution. Alternatively, device 402 may download pieces of the computer readable instructions, as needed, or some instructions may be executed at device 402 and some at computing device 420.

Various operations of embodiments are provided herein. In one embodiment, one or more of the operations described may comprise computer readable instructions stored on one or more computer readable media, which if executed by a computing device, will cause the computing device to perform the operations described. The order in which some or all of the operations are described should not be construed as to imply that these operations are order dependent. Alternative ordering will be appreciated by one skilled in the art having the benefit of this description. Further, it will be understood that not all operations are present in each embodiment provided herein.

Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

As used in this application, the terms “system”, “component,” “interface”, “module,” and the like are generally intended to refer to a computer-related entity, either hardware, software, a combination of hardware and software, or software in execution. For example, a component may be, but is not limited to being, an object, a process running on a processor, a processor, a program, an executable, a thread of execution, and/or a computer. By way of illustration, an application running on a controller and the controller can be a component. One or more components may reside within a thread of execution and/or process and a component may be distributed between two or more computers and/or localized on one computer.

Furthermore, the claimed subject matter may be implemented as an apparatus, method, and/or article of manufacture using standard programming and/or engineering techniques to produce hardware, firmware, software, or any combination thereof to control a computer that may implement the disclosed subject matter. The term “article of manufacture” as used herein is intended to encompass a computer program (e.g., accessible from any computer-readable device, carrier, or media). Of course, those skilled in the art will recognize many modifications may be made to this configuration without departing from the scope or spirit of the claimed subject matter.

Moreover, the word “exemplary” is used herein to mean serving as an example, illustration, or instance. Any design or aspect described herein as “exemplary” is not necessarily to be construed as advantageous over other designs or aspects. Rather, use of the word “exemplary” is intended to present concepts in a concrete fashion. As used in this application, the word “or” is intended to mean an inclusive “or” (e.g., rather than an exclusive “or”). That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the words “a” and “an” as used in this application and the appended claims may generally be construed to mean “one or more” (e.g., unless specified otherwise or clear from context to be directed to a singular form). Also, at least one of A or B or the like generally means A or B or both A and B. Furthermore, to the extent that the terms “includes”, “having”, “has”, “with”, or variants thereof are used in either the detailed description or the claims, such terms are intended to be inclusive in a manner similar to the term “comprising.”

Although the disclosure has been shown and described with respect to one or more implementations, modifications and alterations will occur to others skilled in the art based (e.g., at least in part) upon a reading of this specification and the annexed drawings. The disclosure includes all such modifications and alterations. The disclosure is limited only by the scope of the following claims. In regard to the various functions performed by the above described components (e.g., resources, elements, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. Additionally, while a particular feature of the disclosure may have been disclosed with respect to only one of several implementations, the particular feature may be combined with one or more other features of the other implementations as may be desired and/or advantageous for any given or particular application.

What is claimed is:

1. A method of a review system, comprising:
identifying a first item;
identifying one or more internet resources associated with the first item, wherein each internet resource of the one or more internet resources comprises one or more reviews of the first item;
analyzing the one or more internet resources to identify a plurality of reviews of the first item;
selecting a subset of reviews, from among the plurality of reviews, based upon a determination that reviews of the subset of reviews are authentic;
generating, based upon the subset of reviews, first review information associated with the first item;
receiving, from a client device, a request for review information;
determining that the request is associated with the first item; and
in response to the determining that the request is associated with the first item, displaying, via the client device, an authentic review interface comprising one or more graphical objects indicative of the first review information associated with the first item.

2. The method of claim 1, wherein:
the generating the first review information comprises analyzing a review of the subset of reviews to identify one or more item attributes, of the first item, discussed in the review, wherein the one or more graphical objects comprise:
the review; and
the one or more item attributes.

3. The method of claim 1, wherein:
the generating the first review information comprises generating, based upon the subset of reviews, an authentic review report indicative of at least one of:
positive attributes, of the first item, indicated by one or more first reviews of the subset of reviews; or
negative attributes, of the first item, indicated by one or more second reviews of the subset of reviews; and
the one or more graphical objects comprises the authentic review report.

4. The method of claim 3, wherein:
the generating the first review information comprises at least one of:
determining a first measure of reviews, of the subset of reviews, that are indicative of a first positive attribute of the positive attributes of the first item; or
determining a second measure of reviews, of the subset of reviews, that are indicative of a first negative attribute of the negative attributes of the first item; and
the authentic review report is indicative of at least one of the first measure of reviews or the second measure of reviews.

5. The method of claim 1, wherein:
the one or more graphical objects comprises one or more reviews of the subset of reviews.

6. The method of claim 1, wherein:
the method comprises determining review scores of reviews of the subset of reviews;
a review score of the review scores is indicative of a review quality of a review of the reviews; and
the one or more graphical objects comprises:
the review; and
an indication of the review score.

7. The method of claim 6, wherein:
an order in which the reviews are displayed in the authentic review interface is based upon the review scores.

8. The method of claim 1, wherein:
the request is received in association with the client device at least one of accessing an internet resource or requesting to access the internet resource;
the request identifies the internet resource;
the method comprises determining, based upon information associated with the internet resource and item identification information associated with the first item, that the internet resource is associated with the first item; and
the determining that the request is associated with the first item is based upon the determining that the internet resource is associated with the first item.

9. The method of claim 8, wherein:
a graphical object of the one or more graphical objects of the authentic review interface is displayed between first content of the third internet resource and second content of the third internet resource.

11. The method of claim 1, wherein:
the request comprises a first image captured via a camera; and
the method comprises:
generating item information based upon the first image; and
determining, based upon the item information and item identification information associated with the first item, that the first image is associated with the first item; and
the determining that the request is associated with the first item is based upon the determining that the first image is associated with the first item.

12. The method of claim 1, comprising:
analyzing the one or more internet resources to identify one or more prices, of the first item, indicated by the one or more internet resources, wherein the authentic review interface comprises one or more indications of the one or more prices.

13. The method of claim 1, wherein:
the identifying the one or more internet resources comprises:
analyzing first information associated with a first shopping platform to determine that a first shopping internet resource, of the first shopping platform, comprises one or more first reviews associated with the first item, wherein the one or more internet resource comprises the first shopping internet resource; and
analyzing second information associated with a second shopping platform to determine that a second shopping internet resource, of the second shopping platform, comprises one or more second reviews associated with the first item, wherein the one or more internet resources comprise the second shopping internet resource; and
the plurality of reviews of the first item comprises the one or more first reviews of the first shopping internet resource and the one or more second reviews of the second shopping internet resource.

14. The method of claim 13, wherein:
the subset of reviews comprises a first review of the one or more first reviews and a second review of the one or more second reviews; and
the request is received in association with the client device at least one of accessing a third internet resource or requesting to access the third internet resource;
the request identifies the third internet resource;
the method comprises determining, based upon information associated with the third internet resource and item identification information associated with the first item, that the third internet resource is an internet resource associated with the first item;
the third internet resource is a shopping internet resource of a third shopping platform different than at least one of the first shopping platform or the second shopping platform; and
the determining that the request is associated with the first item is based upon the determining that the third internet resource is associated with the first item.

15. The method of claim 14, wherein:
a graphical object of the one or more graphical objects of the authentic review interface is displayed between first content of the third internet resource and second content of the third internet resource.

16. The method of claim 15, wherein:
the method comprises determining review scores of reviews, of the subset of reviews, comprising the first review and the second review;
a first review score of the review scores is indicative of a review quality of the first review;
a second review score of the review scores is indicative of a review quality of the second review; and
the one or more graphical objects comprise:
the first review;
the second review;
an indication of the first review score; and
an indication of the second review score.

17. The method of claim 16, wherein:
an order in which the reviews are displayed in the authentic review interface is based upon the review scores.

18. The method of claim 15, wherein:
the method comprises determining review scores of reviews, of the subset of reviews, comprising the first review and the second review; and
the generating the first review information comprises determining an item rating of the first item based upon ratings of the reviews and the review scores;
a first review score of the review scores corresponds to a review quality of the first review;
a second review score of the review scores corresponds to a review quality of the second review; and
the one or more graphical objects comprise an indication of the item rating.

19. A computing device comprising:
a processor; and
memory comprising processor-executable instructions that when executed by the processor cause performance of operations, the operations comprising:
identifying a first item;
identifying one or more internet resources associated with the first item, wherein each internet resource of the one or more internet resources comprises one or more reviews of the first item;
analyzing the one or more internet resources to identify a plurality of reviews of the first item;
selecting a subset of reviews, from among the plurality of reviews, based upon a determination that reviews of the subset of reviews meet one or more conditions comprising at least one of a condition that a review is authentic or a condition that a review score corresponding to a review quality of a review meets a threshold review score;
generating, based upon the subset of reviews, first review information associated with the first item;
receiving, from a client device, a request for review information;
determining that the request is associated with the first item; and
in response to the determining that the request is associated with the first item, displaying, via the client device, a review interface comprising one or more graphical objects indicative of the first review information associated with the first item.

20. A non-transitory machine-readable medium having stored thereon processor-executable instructions that when executed cause performance of operations of a review system, the operations of the review system comprising:
identifying a first item;
identifying one or more internet resources associated with the first item, wherein each internet resource of the one or more internet resources comprises one or more reviews of the first item;
analyzing the one or more internet resources to identify a plurality of reviews of the first item;
selecting a subset of reviews, from among the plurality of reviews, based upon a determination that reviews of the subset of reviews are authentic;
generating, based upon the subset of reviews, first review information associated with the first item;
receiving, from a client device, a request for review information;
determining that the request is associated with the first item; and
in response to the determining that the request is associated with the first item, displaying, via the client device, an authentic review interface comprising one or more graphical objects indicative of the first review information associated with the first item.
